(19) United States
(12) Patent Application Publication
(10) Pub. No.: US 2003/0163304 A1
(43) Pub. Date: Aug. 28, 2003

(54) Error concealment for voice transmission system

(76) Inventors: Fisseha Mekuria, Lund (SE); Jan Aberg, Lund (SE)

Correspondence Address: JENKENS & GILCHRIST, 3200 Fountain Place, 1445 Ross Avenue, Dallas, TX, 75202-2799, US

(21) Appl. No.: 10/090,098

(22) Filed: Feb. 28, 2002

(51) Int. Cl. G10L 11/04

(52) U.S. Cl. 704/207

(57) ABSTRACT

In a voice communication system such as the Bluetooth Short Range Radio System, wherein transmission of voice information through an air interface is represented by a succession of frames of signal data samples respectively contained in a succession of pitch synchronous frames, and wherein one or more of the data frames may be lost due to interference, a method is disclosed for improving quality of voice information at the system receiver. The method includes the steps of computing a threshold value associated with a particular pitch synchronous frame, and selectively comparing an average magnitude of the particular pitch synchronous frame with the threshold value to detect loss of a data frame contained in the particular pitch synchronous frame. When loss is detected, the loss is concealed at the receiver by replacing the particular pitch synchronous frame with a replica of the pitch synchronous frame which immediately precedes the particular frame in the succession of pitch synchronous frames.

### BACKGROUND OF THE INVENTION

The invention disclosed and claimed herein generally pertains to communication systems for transmitting voice information through an interface, wherein transmitted data may be represented by successive frames of data samples. More particularly, the invention pertains to wireless communication systems of the above type wherein the data frames are transmitted through a synchronous communication channel, and some of the frames may be erased or lost due to interference. Even more particularly, the invention pertains to a method and apparatus for systems of the above type, wherein lost frames are detected and errors caused by the lost frames are concealed to improve voice quality at the system receiver.

As is well known in the art, there is increasing interest in providing computers, telephones and other small electronic devices with the capability to connect and communicate wirelessly with one another, over short ranges, by means of radio links. Such capability could conceivably eliminate or substantially reduce the need for cables or infrared connections between devices such as computers and peripherals, between phones and headsets, and between televisions and their remote controls. Moreover, a number of devices could thereby be readily joined together to form small networks, or multiple networks, within a building or even within a single room.

The assignee herein, a major supplier of mobile telecommunications equipment and systems, has initiated a program to develop a wireless communication capability of the above type. This program, known as the “Bluetooth Short Range Radio System,” is now supported by a number of large electronics industry vendors and suppliers. A Bluetooth specification has now been developed, for a very small radio module which is to be built into computers, telephones, entertainment equipment, and the like. Bluetooth devices are intended to communicate at 2.45 Ghertz over the Industrial, Scientific and Medical (ISM) band, which is unlicensed and globally available. Bluetooth may be adapted for either asynchronous communication, i.e., transmission in only one direction at a time, or for synchronous communication, i.e., transmission in both directions simultaneously.

It has been found that communication over the Bluetooth synchronous communication channel (SCO) for voice transmission can be very sensitive to interference from sources that use the same open ISM band, such as WLAN 802.11b devices, as well as from microwave ovens and the like. The voice coder or codec used for voice coding on the SCO channel, which is a Continuously Variable Slope Delta modulation (CVSD) voice codec, is sufficiently robust for limited bit error conditions resulting from such interference. However, entire frames of data can be erased or lost due to the interference, and for this situation the codec robustness does not help. Moreover, in accordance with the present state of the art for Bluetooth, a lost data frame is muted and replaced with a special bit sequence of 0, 1, 0, 1 . . . in the CVSD bitstream. This practice has been shown to reduce the transient nature of the frame erasure or loss. However, it does not improve voice quality, particularly during a high percentage of erasures caused by for instance 802.11b WLAN interference.

### SUMMARY OF THE INVENTION

Embodiments of the invention are directed to an error concealment scheme for improving voice quality during interference generated frame erasures in a voice transmission system. More particularly, a pitch synchronous waveform based error concealment scheme is disclosed, which would remove the effect of the lost data frames and improve subjective voice quality at the system decoder. Important benefits provided by embodiments of the invention include simplicity or reduced complexity in construction and operation. Moreover, the invention requires no information from the voice codec generating the pulse code modulated (PCM) waveform, and is thus independent therefrom. In a very useful embodiment lost data frames are muted by the CVSD voice codec, as described above. Embodiments of the invention are very usefully employed in connection with the Bluetooth communication system.

The term “data frame” is used herein to refer to a frame of data having a packet length of the systems such as Bluetooth, GSM and UMTS. A “pitch synchronous frame,” as used herein, has a pitch synchronous frame period which is the period between the positive peaks of two consecutive waveforms. Usually the pitch period is longer than the packet frame so that a pitch synchronous frame as defined in the PCM error concealment system can contain a lost packet or data frame as a subset of the total pitch synchronous frame.

In one embodiment of the invention, a method is provided for improving quality of voice information at the receiving side of a voice communication system, wherein the voice information is transmitted through an interface and is represented by a succession of data frames respectively contained in a succession of pitch synchronous frames, at least one of the data frames subject to being lost as a result of interference in the interface. The method comprises the steps of detecting a particular pitch synchronous frame which has lost a data frame at the receiving side, or system receiver, and replacing the particular pitch synchronous frame with a replica of a pitch synchronous frame which immediately precedes the particular pitch synchronous frame in the succession of pitch synchronous frames.

In a preferred embodiment, the detecting step is carried out by computing a threshold value associated with the particular pitch synchronous frame, and selectively comparing an average magnitude of the particular frame with the threshold value. Preferably, a difference value is computed by subtracting the average magnitude of the particular pitch synchronous frame from an average magnitude associated with the immediately preceding pitch synchronous frame. Loss of the particular frame is then indicated if the difference value is found to exceed the threshold value.

An embodiment of the invention may also include the step of estimating a pitch synchronous period associated with the transmitted voice information. Usually, this is accomplished by generating a train of signal samples from the voice information, wherein the samples collectively represent a succession of signal waveforms. Respective positive peaks of the waveforms are identified, and the period between two consecutive positive peaks based on an adaptive threshold is computed to provide the pitch synchronous frame period estimate.

### BRIEF DESCRIPTION OF THE DRAWINGS

FIG. 1 is a block diagram showing a communication system which is provided with an embodiment of the invention.

FIG. 2 is a block diagram showing an embodiment of the invention.

FIG. 3 is a waveform diagram showing a pitch synchronous frame which has lost a data frame.

FIG. 4 shows the waveform diagram of FIG. 3 after correction in accordance with an embodiment of the invention.

### DETAILED DESCRIPTION OF A PREFERRED EMBODIMENT

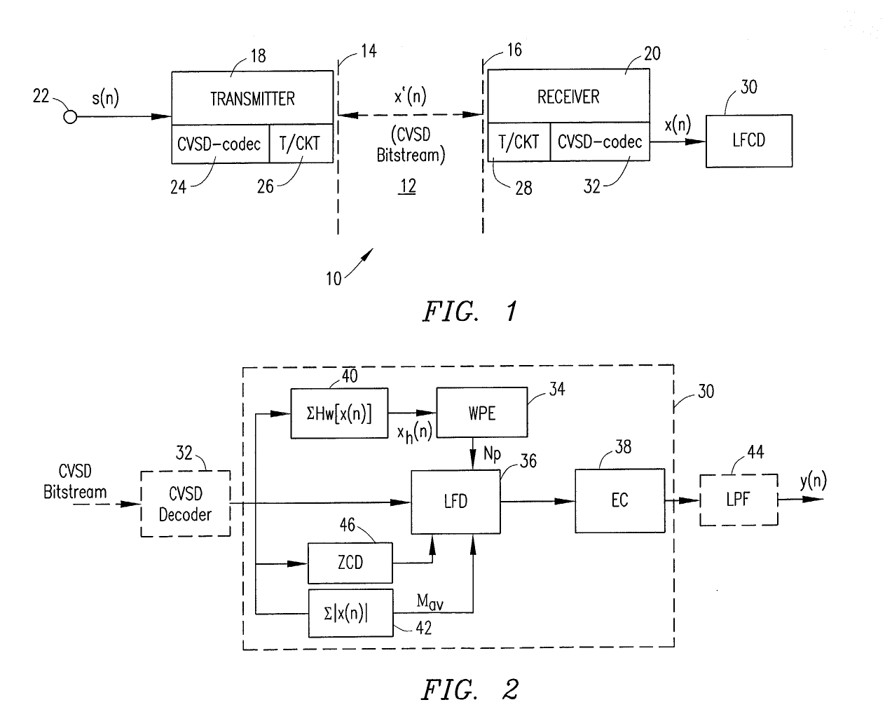

Referring to FIG. 1, there is shown a communication system 10 for transmitting an audio frequency signal s(n) through or across an air interface 12, from the transmitter side 14 of the interface to the receiver side 16 thereof. Communication system 10 comprises a transmitter 18 and components associated therewith, located on transmitter side 14, and further comprises a receiver 20 and components associated therewith, located on receiver side 16. Transmitter 18 and receiver 20 respectively comprise conventional devices, and only some of their components are shown. While communication system 10 usefully comprises the Bluetooth system referred to above, the invention is by no means limited thereto.

Audio signal s(n) represents a digital sample value. Accordingly, signal s(n) is generated by a microphone and an analog-to-digital converter, or other source 22 containing voice or speech components. Accordingly, FIG. 1 further shows transmitter 18 provided with a CVSD encoder 24, or voice codec. Codec 24 is usefully operable at 64 kb/s and implements a voice encoder algorithm to encode the speech components of signal s(n). The encoded signal, comprising a CVSD bitstream of successive signal samples x′(n), is transmitted across air interface 12 by a transmission circuit 26 of transmitter 18, and is received by reception circuit 28 of receiver 20. The received signal is then decoded, by a CVSD decoder 32. As stated above, the encoded voice signal, comprising data samples x′(n), is transmitted across air interface 12 through a synchronous communication channel (SCO). The voice signal samples x′(n) represent a succession of waveforms, each having a positive peak. Successive samples x′(n) are grouped into sets of data frames, respectively contained in a succession of pitch synchronous frames wherein the length of a pitch synchronous frame is equal to the spacing between two consecutive positive peaks.

As likewise stated above, interference in the air interface 12 can cause a data frame of samples x′(n) to be lost or erased. System 10 is designed to respond to frame erasure by muting the lost data frame in the CVSD bitstream. In accordance with the invention, it has been recognized that this action will cause a sudden fall in signal energy, in the bitstream position associated with the lost data frame and in its corresponding pitch synchronous frame.

Referring further to FIG. 1, there is shown receiver 20 provided with CVSD decoder 32 for decoding the received signal x′(n) to provide a pulse code modulated (PCM) signal x(n), likewise comprising successive signal samples. The signal samples x(n) are applied to a lost frame concealment device 30, constructed to operate in accordance with an embodiment of the invention as hereinafter described.

Referring to FIG. 2, there is shown lost frame concealment device 30 comprising, as its principal components, a waveform pitch estimator (WPE) 34, a lost frame detector (LFD) 36, and an error concealment (EC) block 38. Device 30 further includes a halfwave rectifier 40, which receives the signal samples x(n) and provides rectified signal xₕ(n) therefrom. WPE 34 is provided to estimate the pitch period of signal x(n), and receives the halfwave rectified signal xₕ(n) as an input. Using the halfwave rectified signal reduces the number of signal samples which must be processed by WPE 34, and also helps to avoid ambiguity during calculation of the pitch period.

In its operation WPE 34 bases detection of pitch period on short time waveform pitch computation and long time pitch comparison. WPE 34 performs a low pass filter operation, to extract the pitch frequency signals from its input signal. WPE 34 also computes an adaptive value 2/NₚΣxₕ(n), the average amplitude of its input signal xₕ(n). Nₚ is the number of signal samples between two consecutive positive peaks above a threshold of the waveforms represented by the signal x(n), and thus indicates the period between the two positive peaks, which is the pitch synchronous frame period. WPE 34 compares respective samples xₕ(n) with the average amplitude value, and excludes samples which are less than such value. It will be readily apparent that no sample which is less than the average amplitude value can be a positive peak value of the waveforms represented by the samples. The remaining signal samples xₕ(n), that is, the samples which exceed the average amplitude, are processed by WPE 34 to identify the samples of maximum positive value, thereby indicating the waveform positive peaks. The spacing or period between consecutive positive peaks is then determined, to provide the desired pitch period. Pitch period is represented herein by the number of signal samples Nₚ between the consecutive positive peaks. The number of samples between positive peaks also define the length or duration of successive pitch synchronous frames.

In a useful embodiment WPE 34 is constructed and operated in accordance with teachings of U.S. Pat. No. 5,970,441, issued Oct. 19, 1999 to F. Mekuria, one of the inventors herein, such as the teachings at column 4, lines 18-67 and column 5, lines 1-10 thereof.

Referring further to FIG. 2, there is shown lost frame detector 36 receiving the pitch period estimate Nₚ from WPE 34. LFD 36 is also coupled to average magnitude calculator 42, to receive average magnitude values Mₐᵥ therefrom. More specifically, calculator 42 is disposed to compute Mₐᵥᵢ, the average magnitude of pitch synchronous frame i of the signal data samples x(n). Calculator 42 performs this computation by summing the absolute values of such signal samples. Thus, Mₐᵥᵢ is computed as Mₐᵥᵢ1/NₚΣxₐ(n), where xₐ(n)=|x(n)| is the absolute value of x(n). Hence, Mₐᵥᵢ is the sum of Nₚ samples of the pitch synchronous frame i.

As stated above, the detection of a lost frame in the signal waveforms is based on the fact that a sudden fall in signal energy is experienced due to muting of the lost data frame by the SCO communication scheme. Accordingly, LFD 36 is constructed to recognize a lost data frame in pitch synchronous frame i+1 by comparing the average magnitudes for the consecutive pitch synchronous frames i and i+1 and a threshold value Tₘₐᵥ, wherein Tₘₐᵥ and the frame average magnitudes have the following relationship:

$${T}_{mav} = δ \frac{{M}_{avi} + {M}_{avi + 1}}{2} \qquad Eqn . ( 1 )$$

In Equation (1) Mₐᵥᵢ and Mₐᵥᵢ₊₁ are the average magnitudes of pitch synchronous frames i and i+1, respectively. The factor δ is used to control the level of the threshold and avoid low energy non-vocalic segments of speech signals. Usefully, δ varies between 0.8 and 1.2, depending on the amplitude of the incoming signal.

In order to detect a lost data frame, LFD 36 determines whether or not the difference value (Mₐᵥᵢ−Mₐᵥᵢ₊₁) is greater than Tₘₐᵥ. More specifically, a difference value which is greater than Tₘₐᵥ indicates that a data frame in the pitch synchronous frame i+1 has been erased. When this occurs, LFD 36 provides notice to EC block 38. In accordance with the invention, it has been found that computing average magnitude Mₐᵥ from the absolute values of the x(n) signal samples, as described above, significantly enhances the energy difference between a pitch synchronous frame containing a data frame erasure and one with no data frame erasure.

When block 38 is notified that frame i+1 has had a data frame erased, that is, that the difference between the average magnitude of pitch synchronous frame i and the next frame i+1 is greater than the threshold value Tₘₐᵥᵢ, then EC block 38 operates to replace pitch synchronous frame i+1 with a pitch synchronous replica of the frame from the immediately preceding pitch period, that is, pitch synchronous frame i. This rule is alternatively stated as follows:

If (Mₐᵥᵢ−Mₐᵥᵢ₊₁)>Tₘₐᵥ:Frame[Xᵢ₊₁(n)=[Xᵢ(n)] Eqn. (2)

In order to reduce the end effects during PCM waveform replacement, it has been found that a low order low-pass filter (LPF) 44 can be applied to the processed signal. This provides an output signal y(n), of significantly improved voice quality.

Usefully, as further shown by FIG. 2, a zero crossing detector (ZCD) 46 can be employed to improve the performance of the device 30 during consonant sound segments. Zero crossing detector 46 counts the number of zero crossings per frame of the incoming signal. Consonant sounds are more like noise and thus provide a high ZCD value. When data frame erasure occurs the ZCD value changes dramatically, and can thus be used as an indicator of data frame erasure in the case of consonant sounds.

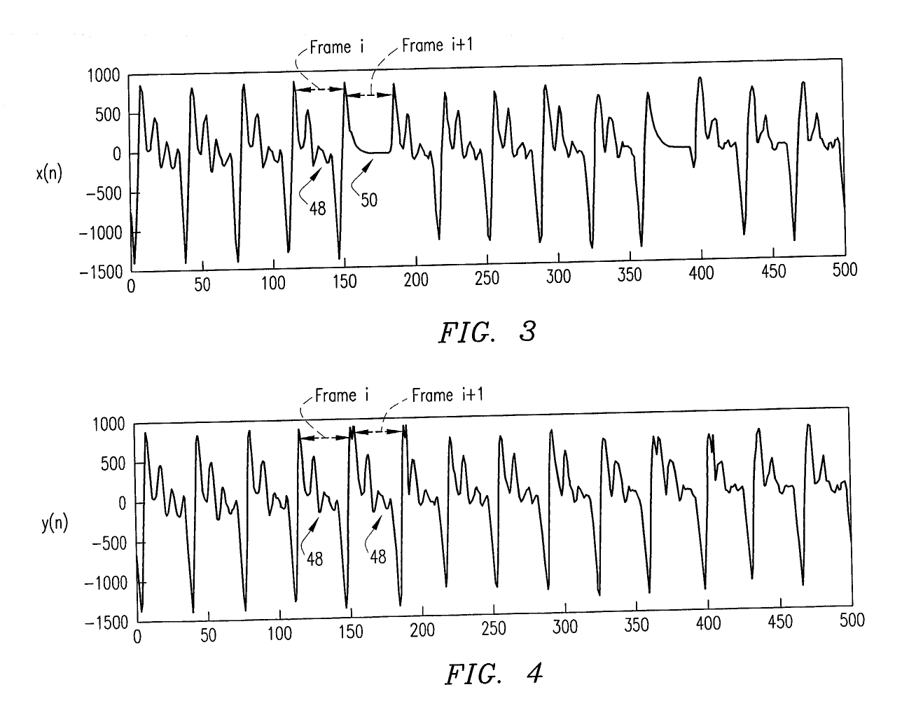

Referring to FIG. 3, there is shown a set of voice waveforms represented by the signal samples x(n). Thus, FIG. 3 shows waveform 48 for pitch synchronous frame i. However, a data frame in pitch synchronous frame i+1 has been erased or muted, by interference or the like, as shown by waveform 50. When LFD 36 recognizes this condition, as described above, error concealment block 38 operates to replace the pitch synchronous frame i+1 with a replica of frame i. This is shown in FIG. 4, which depicts output signal y(n). The vertical axes in FIGS. 3 and 4 represent waveform magnitude, and the respective horizontal axes represent sample number.

Many other modifications and variations of the present invention are possible in light of the above teachings. It is therefore to be understood that within the scope of the disclosed concept, the invention may be practiced otherwise than as has been specifically described.

What is claimed is:

1. In a voice communication system, wherein transmission of voice information through an interface is represented by successive data frames respectively contained in a succession of pitch synchronous frames, and at least one of the data frames is subject to being lost, a method for improving quality of the voice information at a receiving side of the system, the method comprising the steps of:
detecting the loss of a particular data frame at said receiving side; and
replacing the particular pitch synchronous frame containing said lost data frame with a replica of the pitch synchronous frame immediately preceding said particular pitch synchronous frame in said succession.

2. The method of claim 1 wherein said detecting step comprises:
detecting a loss of signal energy associated with said particular pitch synchronous frame.

3. The method of claim 1 wherein said detecting step comprises:
computing a threshold value associated with said particular pitch synchronous frame; and
selectively comparing an average magnitude of said particular pitch synchronous frame with said threshold value.

4. The method of claim 3 wherein:
a difference value is computed by subtracting said average magnitude of said particular pitch synchronous frame from an average magnitude associated with said immediately preceding pitch synchronous frame, loss of said particular pitch synchronous frame being indicated if said difference value exceeds said threshold value.

5. The method of claim 1 wherein:
said method includes the step of estimating a threshold based pitch synchronous period associated with said transmitted voice information.

6. The method of claim 5 wherein said estimating step comprises:
generating a train of signal samples from said voice information, said samples collectively representing a succession of signal waveforms;
identifying respective positive peaks of said waveforms; and
computing the period between two consecutive peaks to provide said pitch synchronous period estimate.

7. The method of claim 6 wherein:
said communication system comprises a Bluetooth voice transmission system.

8. The method of claim 1 wherein:
said system is disposed to mute transmitted data frames affected by interference in said transmission interface.

9. A method for transmitting voice information through an air interface comprising the steps of:
transmitting a succession of data frames of signal samples collectively representing said information into said interface, from a transmission side thereof, said data frames respectively contained in a succession of pitch synchronous frames;
muting a data frame which becomes lost in said interface;
receiving said succession of pitch synchronous frames, including a particular pitch synchronous frame containing said muted data frame, at a receiving side of said interface;
detecting said muted data frame in said particular pitch synchronous frame at said receiving side; and
replacing said particular pitch synchronous frame with a replica of the frame immediately preceding said particular pitch synchronous frame in said pitch synchronous succession.

10. The method of claim 9 wherein said detecting step comprises:
computing a threshold value associated with said particular pitch synchronous frame; and
selectively comparing an average magnitude of said particular pitch synchronous frame with said threshold value.

11. The method of claim 10 wherein:
a difference value is computed by subtracting said average magnitude of said particular pitch synchronous frame from an average magnitude associated with said immediately preceding frame, loss of said muted data frame being indicated if said difference value exceeds said threshold value.

12. The method of claim 11 wherein:
said method includes the step of estimating a pitch period associated with said transmitted voice information.

13. In a voice communication system, wherein transmission of voice information through an interface is represented by data frames respectively contained in a succession of pitch synchronous frames and at least one of the data frames is subject to being lost, apparatus for improving quality of the voice information at a receiving side of the system comprising:
a lost frame detector for detecting the loss of a data frame at said receiving side; and
an error concealment device for replacing the particular pitch synchronous frame containing the lost data frame with a replica of the pitch synchronous frame immediately preceding said particular pitch synchronous frame in said succession.

14. The apparatus of claim 13 wherein said lost frame detector is disposed to detect a loss of signal energy associated with said particular pitch synchronous frame.

15. The apparatus of claim 13 wherein:
said detector is disposed to compute a threshold value associated with said particular pitch synchronous frame and to selectively compare an average magnitude of said particular pitch synchronous frame with said threshold value.

16. The apparatus of claim 15 wherein:
said lost frame detector computes a difference value by subtracting said average magnitude of said particular pitch synchronous frame from an average magnitude associated with said immediately preceding frame, loss of the data frame in said particular pitch synchronous frame being indicated if said difference value exceeds said threshold value.

17. The apparatus of claim 13 wherein:
said apparatus includes a device for estimating a pitch period associated with said transmitted voice information.

18. The apparatus of claim 17 wherein said pitch estimating device is disposed to:
generate a train of signal samples from said voice information, said samples collectively representing a succession of signal waveforms;
identify respective positive peaks of said waveforms; and
compute the period between two consecutive peaks to provide said pitch period estimate.

19. The apparatus of claim 13 wherein:
said communication system comprises a Bluetooth voice transmission system.

20. The apparatus of claim 13 wherein:
said system is disposed to mute transmitted data frames affected by interference in said transmission interface.
